(19) United States
(12) Patent Application Publication
(10) Pub. No.: US 2009/0298970 A1
(43) Pub. Date: Dec. 3, 2009

(54) (METH)ACRYLATES COMPOSITIONS CONTAINING DISPERSIONS OF CORE SHELL RUBBERS IN (METH)ACRYLATES

(75) Inventors: Shabbir Attarwala, Simsbury, CT (US); Qinyan Zhu, Cheshire, CT (US); John J. Cocco, Vernon, CT (US); Ifeanyi C. Broderick, East Hampton, CT (US)

Correspondence Address: Loctite Corporation, One Henkel Way, Rocky Hill, CT, 06067, US

(73) Assignee: Henkel Corporation, Rocky Hill, CT (US)

(21) Appl. No.: 12/487,236

(22) Filed: Jun. 18, 2009

Related U.S. Application Data
(63) Continuation of application No. PCT/US2007/025600, filed on Dec. 13, 2007.
(60) Provisional application No. 60/870,751, filed on Dec. 19, 2006.

(51) Int. Cl. C09D 151/00

(52) U.S. Cl. 523/201

(57) ABSTRACT

The present invention provides a (meth)acrylate composition comprising a (meth)acrylate component; and a core shell rubber component having a particle size in the range of 3 nm to 1,000 nm dispersed in a curable (meth)acrylate matrix.

### BACKGROUND OF THE INVENTION

1. Field of the Invention

The present invention provides a (meth)acrylate composition comprising a (meth)acrylate component; and a core shell rubber component having a particle size in the range of 3 nm to 1,000 nm dispersed in a curable (meth)acrylate matrix.

2. Brief Description of Related Technology

Radical-curable adhesive compositions generally are well-known. In the context of anaerobic adhesives, see e.g., R. D. Rich, “Anaerobic Adhesives” in Handbook of Adhesive Technology, 29, 467-79, A. Pizzi and K. L. Mittal, eds., Marcel Dekker. Inc., New York (1994) and references cited therein. In the context of radiation-curable adhesives, see e.g., J. G. Woods, “Radiation Curable Adhesives” in Radiation Curing: Science and Technology, 333-98, S. P. Pappas, ed., Plenum Press, New York (1992).

Uses of radical-curable adhesives are legion and new applications continue to be developed.

Core shell rubbers are known, and are available for sale commercially from a number of suppliers, including Kaneka Corporation, Hanse Chemie and Wacker Chemie GmbH. Some of these core shell rubbers are available commercially as dispersions in an epoxy resin.

Notwithstanding the state of the art, it would be desirable to provide (meth)acrylate compositions containing core shell rubbers in a premixed dispersion to provide the end user with additional (meth)acrylate product choices, particularly with (meth)acrylate product choices having improved toughness.

### SUMMARY OF THE INVENTION

The present invention provides a (meth)acrylate composition comprising a (meth)acrylate component; and a core shell rubber component having a particle size in the range of 3 nm to 1,000 nm dispersed in a curable (meth)acrylate matrix.

More specifically, the core shell rubber component should have a particle where at least 90% of the particles have a particle size distribution in the range of 3 nm to 500 nm.

In addition, to form the premix the core shell rubber component should be dispersed in the curable (meth)acrylate matrix in an amount in the range of 5% by weight to about 75% by weight, such as in the range of 15% by weight to about 65% by weight, desirably in an amount in the range of 25% by weight to about 50% by weight.

The core shell rubber component/curable (meth)acrylate matrix premix dispersion should be present with the (meth)acrylate component in an amount in the range of 5% by weight to about 65% by weight, such as in an amount in the range of 10% by weight to about 50% by weight, desirably in an amount in the range of 15% by weight to about 35% by weight and more desirably in an amount in the range of 20% by weight to about 25% by weight %.

### DETAILED DESCRIPTION OF THE INVENTION

The present invention provides a (meth)acrylate composition comprising a (meth)acrylate component; and a core shell rubber component having a particle size in the range of 3 nm to 1,000 nm dispersed in a curable (meth)acrylate matrix.

More specifically, the core shell rubber component should have a particle where at least 90% of the particles have a particle size distribution in the range of 3 nm to 500 nm.

The nano core shell rubber should have a core of a rubbery polymer and a shell of a glassy polymer and being compatible but not miscible with the (meth)acrylate monomer.

Such nano core shell rubbers generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.). For example, the core may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) while the shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. Other rubbery polymers may also be suitably be used for the core, including polybutylacrylate or polysiloxane elastomer (e.g., polydimethylsiloxane, particularly crosslinked polydimethylsiloxane). The rubber particle may be comprised of more than two layers (e.g., a central core of one rubbery material may be surrounded by a second core of a different rubbery material or the rubbery core may be surrounded by two shells of different composition or the rubber particle may have the structure soft core, hard shell, soft shell, hard shell). In one embodiment of the invention, the rubber particles used are comprised of a core and at least two concentric shells having different chemical compositions and/or properties. Either the core or the shell or both the core and the shell may be crosslinked (e.g., ionically or covalently). The shell may be grafted onto the core. The polymer comprising the shell may bear one or more different types of functional groups (e.g., epoxy groups) that are capable of interacting with other components of the compositions of the present invention.

Typically, the core will comprise from about 50 to about 95 percent by weight of the rubber particles while the shell will comprise from about 5 to about 50 percent by weight of the rubber particles.

The core shell rubber particles are on the nano scale size. That is, the rubber particles have an average diameter of less than about 500 nm, such as less than about 200 nm, desirably in the range of 25 to 100 nm.

Methods of preparing rubber particles having a core shell structure are well-known in the art and are described, for example, in U.S. Pat. Nos. 4,419,496, 4,778,851, 5,981,659, 6,111,015, 6,147,142 and 6,180,693, each of which being incorporated herein by reference in its entirety.

Rubber particles having a core-shell structure may be prepared as a masterbatch where the rubber particles are dispersed in a matrix. In the context of the present invention, the matrix is a (meth)acrylate matrix. For example, the rubber particles typically are prepared as aqueous dispersions or emulsions. Such dispersions or emulsions may be combined with the desired epoxy resin or mixture of epoxy resins and the water and other volatile substances removed by distillation or the like. One method of preparing such masterbatches is described in more detail in International Patent Publication No. WO 2004/108825, incorporated herein by reference in its entirety. For example, an aqueous latex of rubber particles may be brought into contact with an organic medium having partial solubility in water and then with another organic medium having lower partial solubility in water than the first organic medium to separate the water and to provide a dispersion of the rubber particles in the second organic medium. This dispersion may then be mixed with the desired epoxy resin(s) and volatile substances removed by distillation or the like to provide the masterbatch.

Particularly suitable dispersions of rubber particles having a core shell structure in an epoxy resin matrix are available from Kaneka Corporation, such as Kaneka MX-120 (masterbatch of 25% by weight nano-sized core-shell rubber in a diglycidyl ether of bisphenol A matrix) and Kaneka MX-156. Here, again the matrix is a (meth)acrylate matrix.

The core phase and the shell phase of the core shell rubber may be grafted to one another. These nano core shell rubbers may be prepared by a continuous, multi-step emulsion polymerization method, what is called a multi-step seed emulsion polymerization method, where the polymer in a posterior step is subjected to seed polymerization successively in the presence of the polymer of a prior step. First, seed latex is prepared by emulsion polymerization, then a core portion is prepared by seed polymerization, and the seed polymerization is then repeated, whereby a core shell rubber can be obtained.

Thus, the polymerization of seed particles may be accomplished using a monomer, such as methyl methacrylate or ethyl acrylate.

The polymerization of the core may be accomplished using emulsion polymerization of a conjugated diene or an alkyl acrylate monomer (having an alkyl group with 2 to 8 carbon atoms), in the presence of seed latex. In this way, a core based on a rubbery polymer having a glass transition temperature (Tg) below room temperature, preferably below −10° C. Examples of the conjugated diene include, for example, butadiene, isoprene, or chloroprene, with butadiene being particularly desirable. Examples of the alkyl acrylate include, for example, ethyl acrylate, propyl acrylate, butyl acrylate, cyclohexyl acrylate, or 2-ethylhexyl acrylate, with butyl acrylate being particularly desirable.

In the copolymerization of the core, together with the alkyl acrylate there may be used a monomer copolymerizable therewith, examples of which include aromatic vinyl and vinylidene monomers such as styrene, vinyltoluene, and methylstyrene, vinyl cyanide and vinylidene cyanide monomers, such as acrylonitrile and methacrylonitrile, and alkyl methacrylates such as methyl methacrylate and butyl methacrylate.

A crosslinkable monomer and a graft monomer are desirable as comonomers. As examples of the crosslinkable monomer are aromatic divinyl monomers such as divinylbenzene, as well as alkane polyol polyacrylates or alkane polyol polymethacrylates such as ethylene glycol diacrylate, ethylene glycol dimethacrylate, butylene glycol diacrylate, hexanediol dimethacrylate, oligoethylene glycol diacrylate, oligoethylene glycol dimethacrylate, trimethylolpropane diacrylate, trimethylolpropane dimethacrylate, trimethylolpropane triacrylate, and trimethylolpropane trimethacrylate, with butylene glycol diacrylate and hexanediol diacrylate being particularly desirable. As examples of the graft monomer are unsaturated carboxylic acid allyl esters such as allyl acrylate, allyl methacrylate, diallyl maleate, diallyl fumarate, and diallyl itaconate, with allyl methacrylate being particularly desirable.

It is preferable that the proportion of the rubbery polymer core be in the range of 50 to 90% by weight of the whole of the core shell rubber.

In the preparation of the core shell rubber, as a polymerization initiator in the monomer emulsion polymerization there may be used, for example, persulfate initiators such as sodium persulfate and potassium persulfate, azo type initiators such as azobisisobutyronitrile, 2,2′-azobis(2-amidinopropane)dihydrochloride, 2,21-azobis (2-imidazoline-2-yl)propane, and dimethyl methylpropaneisobutyrate, and organic peroxide initiators such as cumene hydroperoxide and diisopropyl-benzene hydroperoxide.

The polymer shell is prepared by polymerizing methyl methacrylate or styrene and a monomer copolymerizable therewith in the presence of the core latex to form a glassy polymer having a Tg above room temperature, preferably above 60° C., as an outermost shell. Examples of the monomer copolymerizable with methyl methacrylate are mentioned vinyl polymerizable monomers such as alkyl acrylates, e.g. ethyl acrylate and butyl acrylate, alkyl methacrylates, e.g. ethyl methacrylate and butyl methacrylate, aromatic vinyl and vinylidene monomers, e.g. styrene, vinyltoluene and methylstyrene, and vinyl cyanide and vinylidene cyanide monomers, e.g. acrylonitrile and methacrylonitrile. Particularly preferred are ethyl acrylate, styrene and acrylonitrile. As examples of the monomer copolymerizable with styrene are mentioned vinyl polymerizable monomers such as alkyl acrylates, e.g. methyl acrylate and ethyl acrylate, alkyl methacrylates, e.g. methyl methacrylate and ethyl methacrylate, aromatic vinyl and vinylidene monomers, e.g. vinyltoluene and methylstyrene, and vinyl cyanide and vinylidene cyanide monomers, e.g. acrylonitrile and methacrylonitrile, with methyl methacrylate and acrylonitrile being particularly preferred.

In the core shell rubber prepared according to the present invention there may be present a polymer layer or layers, namely, intermediate layer or layers, between the core and the final polymer layer, or the shell. After the formation of seed or core, such an intermediate layer can be formed by suitably selecting, for example, a polymerizable monomer containing a functional group such as glycidyl methacrylate or unsaturated carboxylic acid, a polymerizable monomer which forms a glassy polymer such as methyl methacrylate, or a polymerizable monomer which forms a rubbery polymer such as butyl acrylate, and then subjecting the thus-selected monomer to emulsion polymerization.

For instance, the core may be formed predominantly from feed stocks of polybutadiene, polyacrylate, polybutadiene/acrylonitrile mixture, polyols and/or polysiloxanes or any other monomers that give a low glass transition temperature. The outer shells may be formed predominantly from feed stocks of polymethylmethacrylate, polystyrene or polyvinyl chloride or any other monomers that give a higher glass transition temperature.

The core shell rubbers made in this way may be dispersed in a (meth)acrylate matrix, with the (meth)acrylate selected from (meth)acrylates that are liquid at the preparation or formulating temperature. For instance, examples of (meth)acrylates include those chosen from a wide variety of materials, such as these represented by H₂C═CGCO₂R⁸, where G may be hydrogen, halogen or alkyl groups having from 1 to about 4 carbon atoms, and R⁸ may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulfur, sulfonate, sulfone and the like.

Mono-functional (meth)acrylates like hydroxyethyl (meth)acrylate (“HEMA”), hydroxypropyl (meth)acrylate (“HPMA”), isobornylacrylate (“IBOA”), and the like may be suitable for use herein, particularly in combination with a di- or tri-functional (meth)acrylate, as set forth below.

Additional (meth)acrylate monomers suitable for use herein include polyfunctional (meth)acrylate monomers, such as di- or tri-functional (meth)acrylates like polyethylene glycol di(meth)acrylates (“PEGMA”), tetrahydrofuran (meth)acrylates and di(meth)acrylates, hexanediol di(meth)acrylate, trimethylol propane tri(meth)acrylates (“TMPTMA”), diethylene glycol dimethacrylate, triethylene glycol dimethacrylates (“TRIEGMA”), tetraethylene glycol di(meth)acrylates, dipropylene glycol di(meth)acrylates, di-(pentamethylene glycol) di(meth)acrylates, tetraethylene diglycol di(meth)acrylates, diglycerol tetra(meth)acrylates, tetramethylene di(meth)acrylates, ethylene di(meth)acrylates, neopentyl glycol di(meth)acrylates, and bisphenol-A mono and di(meth)acrylates, such as ethoxylated bisphenol-A (meth)acrylate (“EBIPMA”), and bisphenol-F mono and di(meth)acrylates, such as ethoxylated bisphenol-A (meth)acrylate.

Still other (meth)acrylate monomers that may be used herein include silicone (meth)acrylate moieties (“SiMA”), such as those taught by and claimed in U.S. Pat. No. 5,605,999 (Chu), the disclosure of which is hereby expressly incorporated herein by reference. Of course, combinations of these (meth)acrylate monomers may also be used.

The core shell rubber may be present in the (meth)acrylate dispersion in an amount in the range of about 5 to about 50% by weight, with about 15 to about 25% by weight being desirable.

Many of the core shell rubbers available from Kaneka are believed to have a core made from a copolymer of (meth)acrylate-butadiene-styrene (“MBS”), where the butadiene is the primary component in the phase separated particles, dispersed in epoxy resins. Other commercially available masterbatches of core-shell rubber particles dispersed in epoxy resins include GENIOPERL M23A (a dispersion of 30% by weight core shell rubber in an aromatic epoxy resin based on bisphenol A diglycidyl ether; the core shell rubbers have an average diameter of ca. 100 nm and contain a crosslinked silicone elastomer core onto which an epoxy-functional acrylate copolymer has been grafted); the silicone elastomer core represents about 65% weight of the core shell rubber), available from Wacker Chemie GmbH, Germany.

In addition, the core shell rubber component should be dispersed in the curable (meth)acrylate matrix in an amount in the range of 1% by weight to about 95% by weight, such as in the range of 15% by weight to about 75% by weight, desirably in an amount in the range of 20% by weight to about 60% by weight.

The core shell rubber component/curable (meth)acrylate matrix dispersion should be present with the (meth)acrylate component in an amount in the range of 1% by weight to about 18% by weight, such as in an amount in the range of 2% by weight to about 15% by weight, desirably in an amount in the range of 4% by weight to about 12% by weight.

The (meth)acrylate component may be chosen from those above, and may be the same or different as the (meth)acrylate used as the matrix for the premix dispersion of the nano core shell rubber.

The compositions may also include a composition for inducing a radical cure of the (meth)acrylate. Radical cure-inducing compositions may be chosen from those which initiate cure through anaerobic mechanisms, photoinitiated (such as UV radiation and UV/VIS radiation) mechanisms, thermally-induced mechanisms and the like.

Anaerobic cure-inducing compositions useful in anaerobically-curable compositions in accordance with the present invention include a variety of components, such as amines (including amine oxides, sulfonamides and triazines). A desirable composition to induce cure in accordance with the present invention includes saccharin, toluidenes, such as N,N-diethyl-p-toluidene and N,N-dimethyl-o-toluidene, acetyl phenylhydrazine, and maleic acid. Of course, other materials known to induce anaerobic cure may also be included or substituted therefor. See e.g., U.S. Pat. Nos. 3,218,305 (Krieble), 4,180,640 (Melody), 4,287,330 (Rich) and 4,321,349 (Rich). Quinones, such as napthoquinone and anthraquinone, may also be included to scavenge free radicals which form.

Photoinitiated cure-inducing compositions may be chosen from a variety of materials, such as those commercially available from Ciba Specialty Chemicals Corp., Tarrytown, N.Y. under the tradename “IRGACURE” and “DAROCUR”, such as “IRGACURE”184 (1-hydroxycyclohexyl phenyl ketone), 907 (2-methyl-1-[4-(methylthio)phenyl]-2-morpholino propan-1-one), 369 [2-benzyl-2-N,N-dimethylamino-1-(4-morpholinophenyl)-1-butanone], 500 (the combination of 1-hydroxy cyclohexyl phenyl ketone and benzophenone), 651 (2,2-dimethoxy-2-phenyl acetophenone), 1700 [the combination of bis(2,6-dimethoxybenzoyl-2,4,4-trimethyl pentyl) phosphine oxide and 2-hydroxy-2-methyl-1-phenyl-propan-1-one] and “DAROCUR” 1173 (2-hydroxy-2-methyl-1-phenyl-1-propane) and 4265 (the combination of 2,4,6-trimethylbenzoyldiphenyl-phosphine oxide and 2-hydroxy 2-methyl-1-phenyl-propan-1-one); photoinitiators available commercially from Dow Chemical Company under the “CYRACURE” tradename, such as “CYRACURE” UVI-6974 (mixed triaryl sulfonium hexafluoroantimonate salts) and UVI-6990 (mixed triaryl sulfonium hexafluorophosphate salts); and the visible light [blue] photoinitiators, dl-camphorquinone and “IRGACURE” 784DC.

Additional photoinitiated cure-inducing compositions may be chosen from those available from Sartomer, Inc., Exton, Pa. under the tradenames “ESACURE” and “SARCAT”. Examples include “ESACURE” KB1 (benzil dimethyl ketal), “ESACURE” EB3 (mixture of benzoin and butyl ethers), “ESACURE” TZT (trimethylbenzophenone blend), “ESACURE” KIP100F (α-hydroxy ketone), “ESACURE” KIP150 (polymeric hydroxy ketone), “ESACURE” KT37 (blend of “ESACURE” TZT and KIP150), “ESACURE” KT046 (blend of triphenyl phosphine oxide, “ESACURE” KIP150 and TZT), “ESACURE” X33 (blend of 2- and 4-isopropylthioxanthone, ethyl 4-(dimethyl amino)benzoate and “ESACURE” TZT], “SARCAT” CD 1010 [triaryl sulfonium hexafluoroantimonate (50% in propylene carbonate)], “SARCAT” DC 1011 [triaryl sulfonium hexafluorophosphate (50% n-propylene carbonate)], “SARCAT” DC 1012 (diaryl iodonium hexafluoroantimonate), and “SARCAT” K185[triaryl sulfonium hexafluorophosphate (50% in propylene carbonate)].

Of course, combinations of such photoinitiated cure-inducing compositions may be used as deemed appropriate by those of ordinary skill in the art.

Thermally-activated latent curing compositions may be chosen from those available commercially from E.I. duPont and de Nemeurs, Wilmington, Del. under the tradenames “LUPERSOL”, “DELANOX-F”, “ALPEROX-F”, “LUCIDOL”, “LUPERCO”, and “LUPEROX”.

Examples include “LUPERSOL” DDM-9 (mixtures of peroxides and hydroperoxides), “LUPERSOL” DDM-30 (mixtures of peroxides and hydroperoxides), “LUPERSOL” DELTA-X-9 (mixtures of peroxides and hydroperoxides), “LUPERSOL” DHD-9 (mixtures of peroxides and hydroperoxides), “LUPERSOL” DFR (mixtures of peroxides and hydroperoxides), “LUPERSOL” DSW-9 (mixtures of peroxides and hydroperoxides), “LUPERSOL” 224 (2,4-pentanedione peroxide), “LUPERSOL” 221 [di(n-propyl)peroxydicarbonate], “LUPERSOL” 225 [di(s-butyl)peroxydicarbonate], “LUPERSOL” 225-M75 [di(s-butyl)peroxydicarbonate], “LUPERSOL” 225-M60 [di(s-butyl)peroxydicarbonate], “LUPERSOL” 223 [di(2-ethylhexyl)peroxydicarbonate], “LUPERSOL”223-M75 [di(2-ethylhexyl)peroxydicarbonate], “LUPERSOL” 223-M40 [di(2-ethylhexyl)peroxydicarbonate], “LUPERSOL” 219-M60 (diisononanoyl peroxide), “LUCIDOL” 98 (benzoyl peroxide), “LUCIDOL” 78 (benzoyl peroxide), “LUCIDOL” 70 (benzoyl peroxide), “LUPERCO” AFR-400 (benzoyl peroxide), “LUPERCO” AFR-250 (benzoyl peroxide), “LUPERCO” AFR-500 (benzoyl peroxide), “LUPERCO” ANS (benzoyl peroxide), “LUPERCO” ANS-P (benzoyl peroxide), “LUPERCO” ATC (benzoyl peroxide), “LUPERCO” AST (benzoyl peroxide), “LUPERCO” AA (benzoyl peroxide), “LUPERCO” ACP (benzoyl peroxide), “LUPERSOL” 188M75 (α-cumylperoxy neodecanoate), “LUPERSOL” 688T50 (1,1-dimethyl-3-hydroxy-butyl peroxyneoheptanoate), “LUPERSOL” 688M50 (1,1-dimethyl-3-hydroxy-butyl peroxyneoheptanoate), “LUPERSOL” 288M75 (α-cumyl peroxyneoheptanoate), “LUPERSOL” 546M75 (t-amylperoxy neodecanoate), “LUPERSOL” 10 (t-butylperoxy neodecanoate), “LUPERSOL” 10M75 (t-butylperoxy neodecanoate), “LUPERSOL” 554M50 (t-amylperoxypivalate), “LUPERSOL” 554M75 (t-amylperoxypivalate), “LUPERSOL” 11 (t-butylperoxypivalate) “LUPERSOL” 665T50 (1-1-dimethyl-3-hydroxy-butylperoxy-2-ethylhexanoate), “LUPERSOL” 665M50 (1-1-dimethyl-3-hydroxy-butylperoxy-2-ethylhexanoate), “LUPERSOL” 256 [2,5-dimethyl-2,5-di(2-ethylhexanoyl peroxy)hexane], “LUPERSOL” 575 (t-amylperoxy-2-ethyl-hexanoate) “LUPERSOL” 575P75 (t-amylperoxy-2-ethyl-hexanoate), “LUPERSOL” 575M75 (t-amylperoxy-2-ethyl-hexanoate), t-butyl peroctoate (t-butylperoxy-2-ethylhexanoate), “LUPERSOL” PMS (t-butylperoxy-2-ethylhexanoate), “LUPERSOL” PDO (t-butylperoxy-2-ethylhexanoate), “LUPERSOL” 80 (t-butyl peroxyisobutyrate), “LUPERSOL” PMA (t-butyl peroxymaleic acid), “LUPERCO” PMA-25 (t-butyl peroxymaleic acid), “LUPERSOL” 70 (t-butyl peroxyacetate), “LUPERSOL” 75-M (t-butyl peroxyacetate), “LUPERSOL” 76-M (t-butyl peroxyacetate), “LUPERSOL” 555M60 (t-amyl peroxy-acetate), “LUPERSOL” KDB (di-t-butyl diperoxyphthalate), “LUPERSOL” TBIC-M75 (OO-t-butyl-O-isopropyl monoperoxycarbonate), “LUPEROX” 118 [2,5-dimethyl-2,5-di(benzoylperoxy)hexane], “LUPERSOL” TBEC [OO-t-butyl-O-(2-ethylhexyl)monoperoxycarbonate], “LUPERSOL” TAEC [OO-t-amyl-O-(2-ethylhexyl)monoperoxycarbonate], “LUPEROX” 500R (dicumyl peroxide), “LUPEROX” 500T (dicumyl peroxide), “LUPERCO” 500-40C (dicumyl peroxide), “LUPERCO” 500-40E (dicumyl peroxide), “LUPERCO” 500-SRK (dicumyl peroxide), “LUPERSOL” 101 [2,5-dimethyl-2,5-di-(t-butylperoxy)hexane], “LUPERSOL” 101-XL [2,5-dimethyl-2,5-di-(t-butylperoxy) hexane], “LUPERCO” 101-P20 [2,5-dimethyl-2,5-di-(t-butylperoxy)hexane], “LUPERSOL” 801 (t-butyl cumyl peroxide), “LUPERCO” 801-XL (t-butyl cumyl peroxide), “LUPEROX” 802 [α,α-bis(t-butylperoxy)diisopropylbenzene], “LUPERCO” 802-40KE [α,α-bis(t-butylperoxy)diisopropylbenzene], “LUPERSOL” 130 [2,5-dimethyl-2,5-di-(t-butylperoxy)hexyne-3], “LUPERCO” 130-XL [2,5-dimethyl-2,5-di-(t-butylperoxy)hexyne-3], “LUPEROX” 2,5-2,5 (2,5-dihydro-peroxy-2,5-dimethylhexane), “LUPERSOL” 230 [n-butyl-4,4-di-(t-butylperoxy)valerate], “LUPERCO” 230-XL [n-butyl-4,4-di-(t-butylperoxy)valerate], “LUPERSOL” 231 [1,1-di(t-butylperoxy)-3,3,5-trimethyl cyclohexane], “LUPERCO” 231-XL [1,1-di(t-butylperoxy) 3,3,5-trimethyl cyclohexane], “LUPERSOL” 231-P75 [1,1-di(t-butylperoxy) 3,3,5-trimethyl cyclohexane], “LUPERCO” 231-SRL [1,1-di(t-butylperoxy)-3,3,5-trimethyl cyclohexane], “LUPERSOL” 331-80B [1,1-di(t-butylperoxy)cyclohexane], “LUPERCO” 331-XL [1,1-di(t-butylperoxy)cyclohexane], “LUPERSOL” 531-80B [1,1-di(t-amylperoxy)cyclohexane], “LUPERSOL” 531-80M [1,1-di(t-amylperoxy)cyclohexane], “LUPERSOL” 220-D50 [2,2-di(t-butylperoxy)butane], “LUPERSOL” 233-M75 [ethyl-3,3-di(t-butylperoxy)butyrate], “LUPERCO” 233-XL [ethyl-3,3-di(t-butylperoxy)butyrate], “LUPERSOL” P-31 [2,2-di-(t-amylperoxy)propane], “LUPERSOL” P-33 [2,2-di-(t-amylperoxy) propane], and “LUPERSOL” 553-M75 [ethyl 3,3-di(t-amylperoxy)butyrate]

Other thermally-activated latent curing compositions include those available commercially from du Pont under the “VAZO” tradename, such as “VAZO” 64 (azobis-isobutyrile nitrile), “VAZO” 167 (butane nitrile, 2-methyl, 2,2′-azobis) and “VAZO” 88 (cyclohexane carbonitrile, 1,1′-azobis).

The radical cure-inducing composition should be present generally within the range of from about 0.001 parts per hundred (“phr”) to about 10 phr, such as from about 1 phr to about 5 phr.

Where an anaerobically curable composition is at hand, the inventive composition may also include other components common to conventional anaerobic adhesive formulation, such as free-radical initiators, free-radical accelerators, inhibitors of free-radical generation, as well as metal catalysts.

A number of well-known initiators of free-radical polymerization may be incorporated into compositions of the present invention including, without limitation, hydroperoxides, such as cumene hydroperoxide (“CHP”), para-menthane hydroperoxide, t-butyl hydroperoxide (“TBH”) and t-butyl perbenzoate.

Such peroxide compounds may be employed in the present invention in the range of from about 0.1 phr to about 10 phr, with about 0.5 phr to about 5 phr being desirable.

Stabilizers and inhibitors (such as phenols including hydroquinone and quinones) may also be employed to control and prevent premature peroxide decomposition and polymerization of the composition of the present invention, as well as chelating agents [such as diethylenetriamine pentaacetic acid (“DTPA”) or the tetrasodium salt of ethylenediamine tetraacetic acid (“EDTA”)] to remove trace amounts of metal contaminants therefrom.

Accelerators may be employed to enhance the rate of cure propagation, such as in amounts in the range of about 0.1 phr to about 5 phr, desirably about 1 phr to about 3 phr. When the accelerator is in the form of a metal catalyst solution or itself a pre-mix, it may be used in an amount in the range of about 0.03 phr to about 0.1 phr.

A thickener may be added to increase the viscosity of the (meth)acrylate composition. Various polymers can be used as thickeners, and examples include poly(methyl methacrylate) (“PMMA”), poly(ethyl methacrylate) (“PEMA”), methacrylate-type copolymers, acrylic rubbers, cellulose derivatives, and polyvinyl acetate. A suitable amount of thickener is generally about 0.01 to 30% by weight, preferably 5.0 to 25% by weight, based on the total weight of the (meth)acrylate composition.

Plasticizers may also be added to the (meth)acrylate component to further aid in durability and impact, heat, and moisture resistance. The plasticizer is preferably present in an amount of about 0.05% to about 25%, more preferably about 1% to about 15%, such as about 5% to about 10%, by weight based on the total weight of the composition.

Perfumes, dyes, pigments, and the like may be added to the inventive composition depending on use purposes in amounts which do not adversely affect the stability of the (meth)acrylate monomer. The use of such additives is within the skill of those practicing in the (meth)acrylate art and need not be detailed herein.

It may also be desirable to co-toughen the inventive composition with a secondary toughening component, such as those disclosed in the context of cyanoacrylate compositions in U.S. Pat. No. 4,440,910 (O'Connor), which pioneered rubber toughened cyanoacrylate compositions through the use of certain organic polymers as toughening additives that are elastomeric, i.e., rubbery, in nature. The '910 patent is thus directed to and claims a curable adhesive comprising a substantially solvent-free mixture of: (a) a cyanoacrylate ester, and (b) about 0.5% to about 20% by weight of an elastomeric polymer. The elastomeric polymer is selected from elastomeric copolymers of a lower alkene monomer and (i) acrylic acid esters, (ii) methacrylic acid esters or (iii) vinyl acetate. More specifically, the '910 patent notes that toughening additives include acrylic rubbers; polyester urethanes; ethylene-vinyl acetates; fluorinated rubbers; isoprene-acrylonitrile polymers; chlorosulfonated polyethylenes; and homopolymers of polyvinyl acetate were found to be particularly useful.

The elastomeric polymers are described in the '910 patent as either homopolymers of alkyl esters of acrylic acid; copolymers of another polymerizable monomer, such as lower alkenes, with an alkyl or alkoxy ester of acrylic acid; and copolymers of alkyl or alkoxy esters of acrylic acid. Other unsaturated monomers which may be copolymerized with the alkyl and alkoxy esters of acrylic include dienes, reactive halogen-containing unsaturated compounds and other acrylic monomers such as acrylamides.

One group of elastomeric polymers are copolymers of methyl acrylate and ethylene, manufactured by DuPont, under the name of VAMAC, such as VAMAC N123 and VAMAC B-124. VAMAC N123 and VAMAC B-124 are reported by DuPont to be a master batch of ethylene/acrylic elastomer.

DuPont supplies materials called VAMAC B-124 and N123, as well as VAMAC G. VAMAC VCS rubber appears to be the base rubber, from which the remaining members of the VAMAC product line are compounded. VAMAC VCS (also called VAMAC MR) is a reaction product of the combination of ethylene, methyl acrylate and monomers having carboxylic acid cure sites, which once formed is then substantially free of processing aids such as the release agents octadecyl amine, complex organic phosphate esters and/or stearic acid, and anti-oxidants, such as substituted diphenyl amine.

Recently, DuPont has provided to the market under the trade designation VAMAC VMX 1012 and VCD 6200, which are rubbers made from ethylene and methyl acrylate. It is believed that the VAMAC VMX 1012 rubber possesses little to no carboxylic acid in the polymer backbone. Like the VAMAC VCS rubber, the VAMAC VMX 1012 and VCD 6200 rubbers are substantially free of processing aids such as the release agents octadecyl amine, complex organic phosphate esters and/or stearic acid, and anti-oxidants, such as substituted diphenyl amine, noted above.

The inventive composition may also be co-toughened with a rubber toughening component having (a) reaction products of the combination of ethylene, methyl acrylate and monomers having carboxylic acid cure sites, (b) dipolymers of ethylene and methyl acrylate, and combinations of (a) and (b), which once the reaction products and/or dipolymers are formed are then substantially free of processing aids, such as the release agents octadecyl amine (reported by DuPont to be available commercially from Akzo Nobel under the tradename ARMEEN 18D), complex organic phosphate esters (reported by DuPont to be available commercially from R.T. Vanderbilt Co., Inc. under the tradename VANFRE VAM), stearic acid and/or polyethylene glycol ether wax, and anti-oxidants, such as substituted diphenyl amine (reported by DuPont to be available commercially from Uniroyal Chemical under the tradename NAUGARD 445).

In addition, a polymer material constructed from polymethyl methacrylate (“PMMA”) and polybutyl acrylate (“PB”) may be involved in the inventive composition as a co-toughener. Polymer materials within this class are referred to as polymethylmethacrylate-block-polybutylacrylate-block polymethylmethacrylate copolymers (“MAM”).

As reported by the manufacturer, Arkema Group, MAM is a triblock copolymer, consisting of about 70% PMMA and 30% PB. MAM is constructed from distinct segments, which provides for the ability to self-assemble at the molecular scale. That is, M confers hardness to the polymer and A confers elastomeric properties to the polymer. A hard polymer segment tends to be soluble in (meth)acrylates, whereas the elastomeric segments provides toughness to the polymeric (meth)acrylate which forms upon cure. MAM also reinforces mechanical properties, without compromising inherent physical properties. MAM is commercially available from the Arkema Group, under the tradename Nanostrength®, with at present two different grades available, i.e., M-22 and M-42.

Arkema promotes the Nanostrength® product line as an acrylic block copolymer that is miscible with many polymers, most of which according to the manufacturer are major industrial epoxy resins. See also U.S. Pat. No. 6,894,113, where in its abstract the '113 patent speaks to a thermoset material with improved impact resistance. The impact resistance is derived from 1 to 80% of an impact modifier comprising at least one copolymer comprising S-B-M, B-M and M-B-M blocks, where each block is connected to the other by means of a covalent bond or of an intermediate molecule connected to one of the blocks via a covalent bond and to the other block via another covalent bond, M is a PMMA homopolymer or a copolymer comprising at least 50% by weight of methyl methacrylate, B is incompatible with the thermoset resin and with the M block and its glass transition temperature Tg is less than the operating temperature of the thermoset material, and S is incompatible with the thermoset resin, the B block and the M block and its Tg or its melting temperature is greater than the Tg of B. S is advantageously reported as being polystyrene and B polybutadiene.

When used, the co-toughener may be put in an amount of up to about 10% by weight, such as up to about 5% by weight, desirably below that 2% by weight to 4% by weight.

The compositions of the present invention may be prepared using conventional methods, well known to those persons of skill in the art. For instance, the components of the inventive compositions may be combined together with mixing in any convenient order consistent with the roles and functions the components are to perform in the compositions. Conventional mixing techniques using known apparatus may be employed.

The compositions of this invention may be applied to a variety of substrates, such as steel, brass, aluminum, zinc and other metals and alloys. In addition, in the context of anaerobic adhesives, synthetic or composite substrates may be used, provided an appropriate primer or activator composition is first applied thereon.

The compositions of this invention may also be used to impregnate the pores of substrates constructed from such materials. See e.g., U.S. Pat. No. 5,618,857, the disclosure of which is hereby expressly incorporated herein by reference.

The following examples should and in further describing the present invention.

### Examples

Here, nano core shell rubber dispersions were prepared as premixes in a (meth)acrylate matrix for addition into a (meth)acrylate-based composition curable by exposure to anaerobic conditions. The (meth)acrylate matrix chosen is PEGMA. Sample No. 1 is used as one control, as it contains no nano core shell rubber and Sample No. 7 is used as a control as it contains no PEGMA.

| | Sample No./Amt (grams) | | | | | | |
|---|---|---|---|---|---|---|---|
| | 1 | 2 | 3 | 4 | 5 | 6 | 7 |
| PEGMA | 100 | 80 | 60 | 50 | 40 | 20 | 0 |
| Nano Core Shell | 0 | 20 | 40 | 50 | 60 | 80 | 100 |
| Rubber | | | | | | | |
| Total | 100 | 100 | 100 | 100 | 100 | 100 | 100 |

Thus, the nano core shell rubber is present in the premixed dispersions in an amount respectively of 0, 20, 40, 50, 60, and 80 weight percent in the (meth)acrylate matrix (here, PEGMA) and as a control 100 weight percent.

(Meth)acrylate compositions are formulated with the premix dispersions identified above, each in a weight percentage of 80% (meth)acrylate base composition and 20% premix dispersion based on Sample Nos. 1-7 above.

The (meth)acrylate base composition is as follows in % by weight:

| | |
|---|---|
| PEGMA | 94.3 |
| Saccharin | 1.6 |
| Free radical stabilizer, HQ | 0.1 |
| Green dye | 0.02 |
| Fluorescent dye | 0.1 |
| Dimethyl-p-toluidene | 0.56 |
| Dimethyl-o-toluidene | 0.28 |
| Metal chelator, EDTA | 0.04 |
| Cumin hydroperoxide | 3 |

Thus, to the (meth)acrylate base composition (0.8 grams) is added each of the premix dispersions (i.e., Sample Nos. 1-7) in an amount of 0.2 grams, yielding the following concentrations of nano core shell rubber:

Formulation 1: 0% nano core shell rubber
Formulation 2: 4% nano core shell rubber
Formulation 3: 8% nano core shell rubber
Formulation 4: 10% nano core shell rubber
Formulation 5: 12% nano core shell rubber
Formulation 6: 16% nano core shell rubber
Formulation 7: 20% nano core shell rubber

Formulation 1 shows no toughening effect due to the nano core shell rubber since none is present. Formulation 7 shows an agglomeration of the nano core shell rubber, resulting in poor mixing and homogeneity. Formulations 2-6 show varying degrees of toughness due to the nano core shell rubber without an agglomeration effect.

What is claimed is:

1. A (meth)acrylate composition comprising:
A (meth)acrylate component; and
A core shell rubber component dispersed in a curable (meth)acrylate matrix, wherein the core shell rubber component has a particle size in the range of 3 nm to 100 nm.

2. The (meth)acrylate composition of claim 1, wherein the core shell rubber component is dispersed in the curable (meth)acrylate matrix in an amount in the range of 1% by weight to about 95% by weight.

3. The (meth)acrylate composition of claim 1, wherein the core shell rubber component is dispersed in the curable (meth)acrylate matrix in an amount in the range of 15% by weight to about 75% by weight.

4. The (meth)acrylate composition of claim 1, wherein the core shell rubber component is dispersed in the curable (meth)acrylate matrix in an amount in the range of 20% by weight to about 60% by weight.

5. The (meth)acrylate composition of claim 1, wherein the core shell rubber component/curable (meth)acrylate matrix dispersion is present with the (meth)acrylate component in an amount in the range of 1% by weight to about 18% by weight.

6. The (meth)acrylate composition of claim 1, wherein the core shell rubber component/curable matrix dispersion is present with the (meth)acrylate component in an amount in the range of 2% by weight to about 15% by weight.

7. The (meth)acrylate composition of claim 1, wherein the core shell rubber component/curable matrix dispersion is present with the (meth)acrylate component in an amount in the range of 4% by weight to about 12% by weight.

8. The (meth)acrylate composition of claim 1, wherein the (meth)acrylate component comprises one or more members selected from the group consisting of polyethylene glycol di(meth)acrylates, tetrahydrofuran (meth)acrylates and di(meth)acrylates, hexanediol di(meth)acrylate, trimethylol propane tri(meth)acrylates, diethylene glycol dimethacrylate, triethylene glycol dimethacrylates (“TRIEGMA”), tetraethylene glycol di(meth)acrylates, dipropylene glycol di(meth)acrylates, di-(pentamethylene glycol) di(meth)acrylates, tetraethylene diglycol di(meth)acrylates, diglycerol tetra(meth)acrylates, tetramethylene di(meth)acrylates, ethylene di(meth)acrylates, neopentyl glycol di(meth)acrylates, and bisphenol-A mono and di(meth)acrylates, such as ethoxylated bisphenol-A (meth)acrylate, hydroxyethyl (meth)acrylate (“HEMA”), hydroxypropyl (meth)acrylate, isobornylacrylate and bisphenol-F mono and di(meth)acrylates.

9. The (meth)acrylate composition of claim 1, wherein the (meth)acrylate composition further comprises a co-toughener selected from the group consisting of elastomeric polymers of a lower alkene monomer and (i) acrylic acid esters, (ii) methacrylic acid esters or (iii) vinyl acetate reaction product of the combination of ethylene, methyl acrylate and monomers having carboxylic acid cure sites, which once formed is then substantially free of processing aids and anti-oxidants, reaction products of the combination of ethylene, methyl acrylate and monomers having carboxylic acid cure sites, dipolymers of ethylene and methyl acrylate, polymer component, constructed from polymethyl methacrylate and polybutyl acrylate segments and combinations thereof.

10. The (meth)acrylate composition of claim 1, wherein the (meth)acrylate composition further comprises a radical cure-inducing composition.

11. The (meth)acrylate composition of claim 1, wherein the (meth)acrylate in which the core shell rubber is dispersed is polyethyleneglycol di(meth)acrylate.
